(19) United States
(12) Patent Application Publication
(10) Pub. No.: US 2024/0429722 A1
(43) Pub. Date: Dec. 26, 2024

(54) DC-DC with Integrated Low Voltage Battery Protection

(71) Applicant: Ford Global Technologies LLC, Dearborn, MI (US)

(72) Inventors: Jiaqi LIANG, La Crescenta, CA (US); Anil PARYANI, Cerritos, CA (US); Luccas DI TULLIO, Redondo Beach, CA (US); Matthew KNOCHE, Clarkston, MI (US)

(21) Appl. No.: 18/748,837

(22) Filed: Jun. 20, 2024

Related U.S. Application Data
(60) Provisional application No. 63/521,955, filed on Jun. 20, 2023.

(51) Int. Cl. H02J 7/00; B60L 3/04

(52) U.S. Cl. CPC H02J 7/0034; H02J 7/00302; H02J 7/00308; B60L 3/04; H02J 2207/20

(57) ABSTRACT

A DC-DC with integrated low voltage battery protection is disclosed.

### CROSS-REFERENCE TO RELATED APPLICATIONS

This application claims the benefit of priority to U.S. Provisional Application No. 63/521,955, filed Jun. 20, 2023, the entire disclosure of which is herein incorporated by reference in its entirety for all purposes.

### FIELD

The relates to a DC-DC converter (or “DC-DC”) with integrated field-effect transistors (FETs) that eliminates a traditional solid-state relay (SSR) in a low voltage lithium-ion (Li-Ion) battery in an Electrified Vehicle.

### BACKGROUND

Typically, a 12V lithium-ion battery in a vehicle contains a solid state relay or contactor to protect against safety failures related to over-charge and short-circuit. The relay is there to protect the occupants, service, and rescue people from a fire or a shock hazard when things go wrong, such as a vehicle crash, runaway charger, or external short in the system.

In addition, there exists a DC-DC that charges the low voltage battery from the high voltage battery. The failure modes of such a DC-DC also include short circuit. Therefore, there exists a typical SSR in the DC-DC as well. FIG. 1 illustrates a typical architecture 100 of an EV system, showing dual DC-DCs to support Level 4 autonomous vehicles.

For critical safety applications like autonomous driving there are typically 12V A and 12V B buses in case one of the two buses goes down.

There are numerous problems with the prior art. For example, the FETs for the 12V battery protection are typically air cooled and therefore many are put in parallel to handle peak currents of the system. In a lot of vehicles, dual DC-DC and dual 12V batteries are employed in case of a short not handled by a fuse box. Such a short may bring down the entire system, which is very costly. Extra FETs are used for DC-DC internal short protection.

### SUMMARY

This disclosure is directed to a DC-DC with integrated low voltage battery protection is disclosed.

In a first aspect of the disclosure, some system circuitry embodiments may include: a DC-DC; a first fuse box; a first FET having a first terminal and a second terminal, the first terminal of the first FET electrically coupled to the DC-DC and to the first fuse box; a second FET having a first terminal and a second terminal, the first terminal of the second FET electrically coupled to the second terminal of the first FET; a second fuse box electrically coupled to the second terminal of the second FET; a battery electrically coupled to the second terminal of the first FET and to the first terminal of the second FET; protection circuitry configured for providing reverse voltage protection or jump start protection, the protection circuitry having a first terminal and a second terminal, the first terminal of the protection circuitry electrically coupled to the battery, to the second terminal of the first FET, and to the first terminal of the second FET; and a jump start post electrically coupled to the second terminal of the protection circuitry.

In some embodiments, the first FET is configured for opening and having its blocking diode prevent the battery from sourcing current, mitigating a first hazard of an internal short of the DC-DC.

In some embodiments, the first FET is configured for opening based on a detection by a drop in voltage or current sensing, mitigating a second hazard of a system short prior to the first fuse box, and the battery is configured to stay alive in a situation of the second hazard, supporting a bus of the second fuse box.

In some embodiments, the second FET is configured for opening based on a detection by a drop in voltage or current sensing, mitigating a third hazard of a system short prior to the second fuse box, and the battery is configured to stay alive in a situation of the third hazard, supporting a bus of the first fuse box.

In some embodiments, the protection circuitry is configured to only allow connection between its first terminal and its second terminal when a certain voltage range is applied on the jump start post, mitigating a fourth hazard of an overcharge of the battery. The protection circuitry can be low current protection circuitry.

In some embodiments, the protection circuitry is configured to remain open between its first terminal and its second terminal, mitigating a fifth hazard of a reverse voltage applied when jump starting.

In some embodiments, the battery is a 12V battery.

In some embodiments, the battery is a lithium-ion battery.

In some embodiments, the battery is a low voltage battery in an electrified vehicle.

In a second aspect of the disclosure, circuitry embodiments may include: a first bus; a second bus; a first DC-DC configured for supporting the first bus and the second bus; a first battery configured for supporting the first bus and the second bus; and a first FET and a second FET on a printed circuit board assembly (PCBA) for the first DC-DC.

In some embodiments, the first FET and the second FET are liquid cooled FETs.

In some embodiments, the first FET and the second FET are not high current FETs.

In some embodiments, the first bus and the second bus are to be supported by the first DC-DC and the first battery based the first FET and the second FET and no other FET.

In some embodiments, the first bus and the second bus are to be supported by the first DC-DC and the first battery based on the first DC-DC and no other DC-DC.

In some embodiments, the first bus and the second bus are to be supported by the first DC-DC and the first battery based on the first battery and no other battery.

In a third aspect of the disclosure, circuitry embodiments may include: protection circuitry configured for preventing over-voltaging or reverse connecting during jump start; a first terminal for electrically coupling the protection circuitry to a battery; and a second terminal for electrically coupling the protection circuitry to a jump start post.

In some embodiments, the protection circuitry includes: a first contactor electrically coupled to the first terminal, the first contactor comprising normally closed contacts; and a second contactor electrically coupled to the second terminal and to the first contactor, the second contactor comprising normally open contacts.

In some embodiments, the first contactor comprises 24V coil with the normally closed contacts.

In some embodiments, the first contactor comprises 12V coil with the normally open contacts.

### BRIEF DESCRIPTION OF THE DRAWINGS

FIG. 1 illustrates a traditional DC-DC and 12V Battery Architecture.

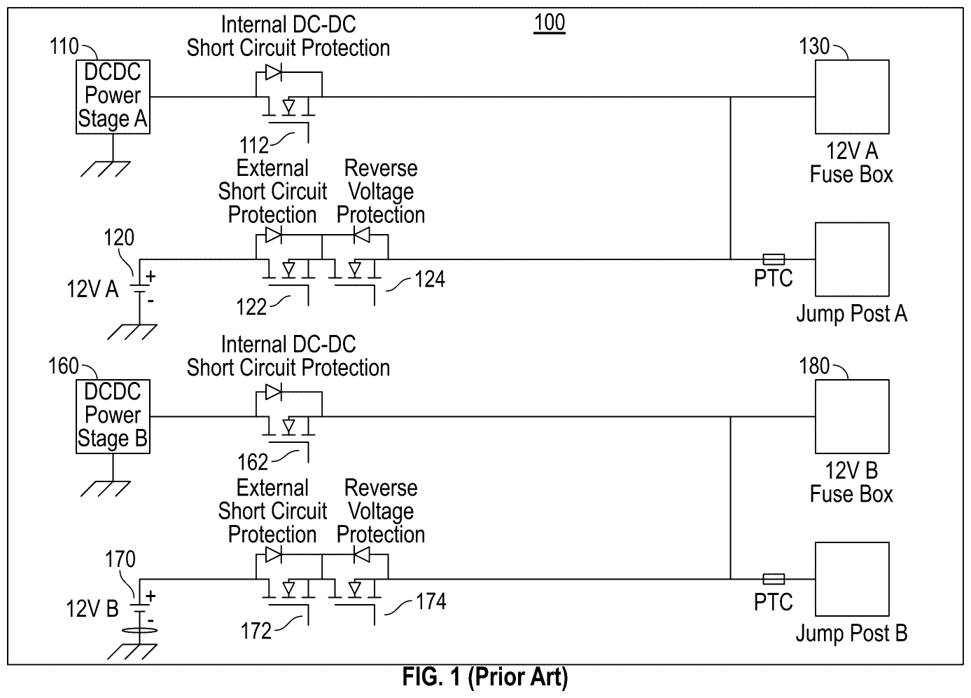

FIG. 2 illustrates the exemplary DCDC with Integrated Battery Protection, according to an embodiment of the disclosure.

### DETAILED DESCRIPTION

Various aspects of the novel systems, apparatuses, and methods are described more fully hereinafter with reference to the accompanying drawings. Aspects of this disclosure may, however, be embodied in many different forms and should not be construed as limited to any specific structure or function presented throughout this disclosure. Rather, these aspects are provided so that this disclosure will be thorough and complete and will fully convey the scope of the disclosure to those skilled in the art.

### Nomenclature

BMS—Battery Management System that may be comprised of fuses, switches, monitoring boards, current sensors, and controllers with communications.

Contactor—any switch, electro-mechanical or completely solid-state or other type.

12V battery—In this patent document disclosure, references to 12V battery can be assumed to be at any low voltage below the shock hazard (e.g., below the shock hazard voltages of 6V (scooters, motorcycles), 12V (passenger car), 24V (heavy duty), 48V (Hybrids, modern vehicles)).

SSR—Solid State Relay.

One or more Safety Goals related to this disclosure may be all related to preventing a vehicle fire and outlined in Table 1 below.

TABLE 1

| Hazard | Traditional Mitigation |
|---|---|
| DC-DC Internal | Open FET (112, 162) outside power stage (110, 160) |
| short | |
| 12V system | 1. Shutdown DC-DC Power Stage A (110) with |
| short on bus A | software controls using current and/or voltage sensors |
| prior to fuse | AND |
| box (130) | 2. Open up FETs (122, 124) outside battery A (120) |
| 12V system | 1. Shutdown DC-DC Power Stage B (160) with |
| short on bus B | software controls using current and / or voltage sensors |
| prior to fuse | AND |
| box (180) | 2. Open up FETs (172, 174) outside battery B (170) |
| 12V Battery | 1. Open up FETs (122, 124, 172, 174) outside battery |
| Overcharge | (120, 170) |
| | AND |
| | 2. Use a current limiting device when jump starting |
| Reverse voltage | 1. Open up FETs (122, 124, 172, 174) outside battery |
| applied when | (120, 170) |
| jump starting | AND |
| | 2. Use a current limiting device when jump starting |

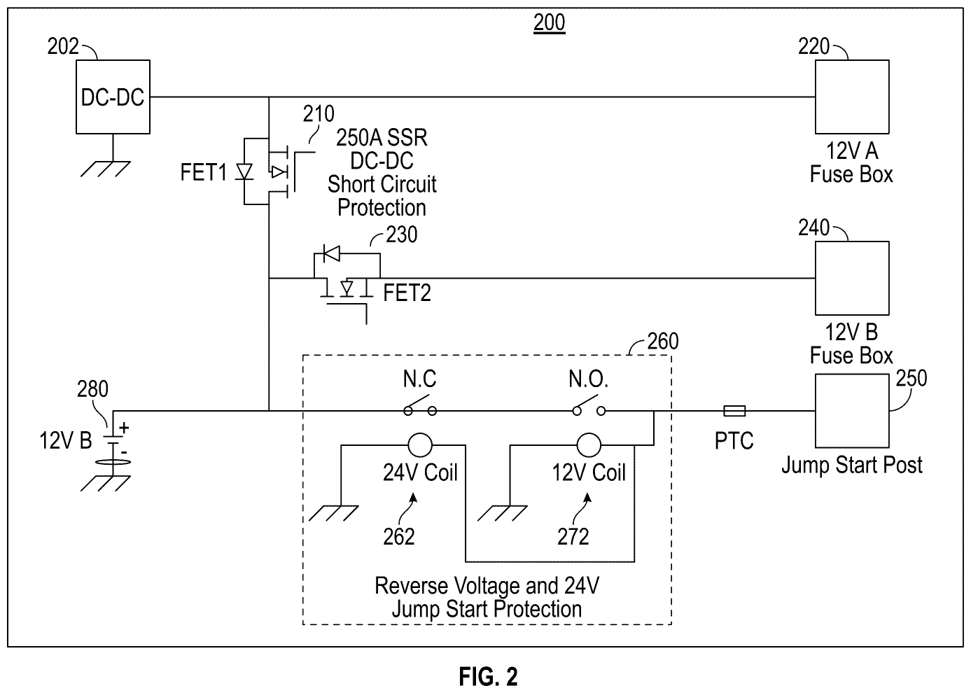

By configuring the FETs as shown in FIG. 2, we can protect the system from some or all the hazards outlined above, but with much lower cost and more reliability due to less FET failed opened situations. Note the FIG. 2 shows one example of reverse voltage protection (RVP) and 24V jump start protection.

Table 2 summarizes the new methods of mitigation provided by the configuration 200 shown in FIG. 2.

TABLE 2

| Hazard | New Method of Mitigation |
|---|---|
| DC-DC (202) | FET1 (210) opens and blocking diode prevents |
| Internal short | 12V battery (280) from sourcing current |
| 12V system short | FET1 (210) opens detected by a drop in voltage |
| prior to fuse box | and/or current sensing. Note that the 12V battery |
| A (220) | (280) can stay alive in this situation still |
| | redundantly supporting 12V B bus. |
| 12V system short | FET2 (230) opens detected by a drop in voltage |
| prior to fuse box | and/or current sensing. Note that the 12V |
| B (240) | battery (280) can stay alive in this situation still |
| | redundantly supporting 12V A bus. |
| 12V Battery (280) | The block (260) in the FIG. 2 above will only allow |
| Overcharge | connection if the right voltage range is applied |
| | on the jump start post (250). Note that this block |
| | (260) can be low current reducing cost. |
| Reverse voltage | The block (260) between the Jump start Post (250) |
| applied when | and 12V battery (280) will remain open. |
| jump starting | |

In FIG. 2, the block 260 may comprise, e.g., two contactors 262 and 272 in the shown arrangement. A first contactor 262 may comprise 24V coil with normally closed (N.C.) contacts. A second contactor 272 may comprise 12V coil with normally open (N.O.) contacts. The block 260 may be involved in protection, e.g., reverse voltage protection (RVP) and 24V jump start protection.

In FIG. 2, the various circuit elements may be shown to be electrically coupled to each other. The illustrated electrical couplings may be implemented in physical embodiments via direct coupling between the illustrated circuitry elements (with no intervening elements) or via indirect coupling between the illustrated circuitry elements (with one or more intervening elements).

In one embodiment, the disclosure relates to the exemplary topology shown in FIG. 2, which can reduce the number of FETs in a system from six high current FETs to just two FETs and elimination of a secondary battery or secondary DC-DC while still supporting dual busses A and B.

In addition, embodiments of the disclosure can eliminate high current FETs in a 12V battery, which are typically air cooled and then need a massive amount of heat sinks in parallel, adding cost, size and weight. Instead, liquid cooled FETs can be employed, with improved heat transfer, on the DC-DC printed circuit board assembly (PCBA), further reducing costs, because less parallel techniques are needed.

Another embodiment discloses a low cost method to prevent over-voltaging or reverse connecting during jump start.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to e-mobility systems, including automotive, some of which are illustrated by way of example in the figures and in the following description of the preferred aspects. The detailed description and drawings are merely illustrative of the disclosure rather than limiting, the scope of the disclosure being defined by the appended claims and equivalents thereof.

What is claimed is:

1. System circuitry comprising:
a DC-DC;
a first fuse box;
a first field-effect transistor (FET) having a first terminal and a second terminal, the first terminal of the first FET electrically coupled to the DC-DC and to the first fuse box;
a second FET having a first terminal and a second terminal, the first terminal of the second FET electrically coupled to the second terminal of the first FET;
a second fuse box electrically coupled to the second terminal of the second FET;
a battery electrically coupled to the second terminal of the first FET and to the first terminal of the second FET;
protection circuitry configured for providing reverse voltage protection or jump start protection, the protection circuitry having a first terminal and a second terminal, the first terminal of the protection circuitry electrically coupled to the battery, to the second terminal of the first FET, and to the first terminal of the second FET; and
a jump start post electrically coupled to the second terminal of the protection circuitry.

2. The system circuitry of claim 1, wherein:
the first FET is configured for opening and having its blocking diode prevent the battery from sourcing current, mitigating a first hazard of an internal short of the DC-DC.

3. The system circuitry of claim 1, wherein:
the first FET is configured for opening based on a detection by a drop in voltage or current sensing, mitigating a second hazard of a system short prior to the first fuse box, and
the battery is configured to stay alive in a situation of the second hazard, supporting a bus of the second fuse box.

4. The system circuitry of claim 1, wherein:
the second FET is configured for opening based on a detection by a drop in voltage or current sensing, mitigating a third hazard of a system short prior to the second fuse box, and
the battery is configured to stay alive in a situation of the third hazard, supporting a bus of the first fuse box.

5. The system circuitry of claim 1, wherein:
the protection circuitry is configured to only allow connection between its first terminal and its second terminal when a certain voltage range is applied on the jump start post, mitigating a fourth hazard of an overcharge of the battery.

6. The system circuitry of claim 5, wherein:
the protection circuitry is low current protection circuitry.

7. The system circuitry of claim 1, wherein:
the protection circuitry is configured to remain open between its first terminal and its second terminal, mitigating a fifth hazard of a reverse voltage applied when jump starting.

8. The system circuitry of claim 1, wherein:
the battery is a 12V battery.

9. The system circuitry of claim 1, wherein:
the battery is a lithium-ion battery.

10. The system circuitry of claim 1, wherein:
the battery is a low voltage battery in an electrified vehicle.

11. Circuity comprising:
a first bus;
a second bus;
a first DC-DC configured for supporting the first bus and the second bus;
a first battery configured for supporting the first bus and the second bus; and
a first FET and a second FET on a printed circuit board assembly (PCBA) for the first DC-DC.

12. The circuitry of claim 11, wherein:
the first FET and the second FET are liquid cooled FETs.

13. The circuitry of claim 11, wherein:
the first FET and the second FET are not high current FETs.

14. The circuitry of claim 11, wherein:
the first bus and the second bus are to be supported by the first DC-DC and the first battery based the first FET and the second FET and no other FET.

15. The circuitry of claim 11, wherein:
the first bus and the second bus are to be supported by the first DC-DC and the first battery based on the first DC-DC and no other DC-DC.

16. The circuitry of claim 11, wherein:
the first bus and the second bus are to be supported by the first DC-DC and the first battery based on the first battery and no other battery.

17. Circuity comprising:
protection circuitry configured for preventing over-voltaging or reverse connecting during jump start;
a first terminal for electrically coupling the protection circuitry to a battery; and
a second terminal for electrically coupling the protection circuitry to a jump start post.

18. The circuitry of claim 17, wherein:
the protection circuitry comprises:
a first contactor electrically coupled to the first terminal, the first contactor comprising normally closed contacts; and
a second contactor electrically coupled to the second terminal and to the first contactor, the second contactor comprising normally open contacts.

19. The circuitry of claim 18, wherein:
the first contactor comprises 24V coil with the normally closed contacts.

20. The circuitry of claim 18, wherein:
the first contactor comprises 12V coil with the normally open contacts.
